(19) United States
(12) Patent Application Publication
(10) Pub. No.: US 2014/0074598 A1
(43) Pub. Date: Mar. 13, 2014

(54) REVERSE ADS

(71) Applicant: F16APPS, Giza (EG)

(72) Inventor: Ahmed Essam Naiem, Giza (EG)

(73) Assignee: F16APPS, Giza (EG)

(21) Appl. No.: 13/672,317

(22) Filed: Nov. 8, 2012

Related U.S. Application Data
(60) Provisional application No. 61/700,057, filed on Sep. 12, 2012.

(51) Int. Cl. G06Q 30/02

(52) U.S. Cl. 705/14.49

(57) ABSTRACT

In general, in one aspect, the invention relates to a system that includes an evaluation engine and a secure storage. The evaluation engine is configured to obtain a plurality of media attributes of a plurality of media items associated with a user, determine a media category and a media subcategory based on the plurality of attributes, wherein the media category comprises the media subcategory, and receive, from a client device, a request for the media subcategory, wherein the request comprises the media category. The evaluation engine is further configured to identify, in response to the request, the media subcategory associated with the media category, determine a source of the request, and provide, to the client device, the media subcategory for the media category based on the source of the request. The secure storage is configured to store the media subcategory for access and identification by the evaluation engine.

### CROSS-REFERENCE TO RELATED APPLICATIONS

Pursuant to 35 U.S.C. §119(e), this application claims benefit of U.S. Provisional Application No. 61/700,057 filed on Sep. 12, 2012, entitled “REVERSE ADS.” The disclosure of the U.S. Provisional Application is incorporated herein by reference in its entirety.

### BACKGROUND

Modern personal communications devices have the capability of downloading different kinds of media for consumption by users. Much of the media consumed by user on these devices is provided without charge by including advertising embedded within the media provided. Advertisers prefer to target advertising to users likely to purchase the products advertised. Users, however, have concerns over personal data being transmitted from their personal communication devices to third-party servers.

### SUMMARY

In general, in one aspect, the invention relates to a system that includes an evaluation engine and a secure storage. The evaluation engine is configured to obtain a plurality of media attributes of a plurality of media items associated with a user, determine a media category and a media subcategory based on the plurality of attributes, wherein the media category comprises the media subcategory, and receive, from a client device, a request for the media subcategory, wherein the request comprises the media category. The evaluation engine is further configured to identify, in response to the request, the media subcategory associated with the media category, determine a source of the request, and provide, to the client device, the media subcategory for the media category based on the source of the request. The secure storage is configured to store the media subcategory for access and identification by the evaluation engine.

In general, in one aspect, the invention relates to a method for tracking a user's preferences. The method includes obtaining a plurality of attributes of a plurality of media items associated with the user, determining, by an evaluation engine, a media category and a media subcategory based on the plurality of attributes, wherein the media category comprises the media subcategory, and receiving, from a user application, a request for the media subcategory, wherein the request comprises the media category. The method further includes identifying, by the evaluation engine in response to the request, the media subcategory associated with the media category, and providing, to the user application, the media subcategory for the media category.

In general, in one aspect, the invention relates to a non-transitory computer readable medium comprising instructions that, when execute by a processor, perform a method for tracking a user's preferences. The method includes obtaining a plurality of attributes of a plurality of media items associated with the user, determining, by an evaluation engine, a media category and a media subcategory based on the plurality of attributes, wherein the media category comprises the media subcategory, and receiving, from a user application, a request for the media subcategory, wherein the request comprises the media category. The method further includes identifying, by the evaluation engine in response to the request, the media subcategory associated with the media category, and providing, to the user application, the media subcategory for the media category.

Other aspects of the invention will be apparent from the following description and the appended claims.

### BRIEF DESCRIPTION OF DRAWINGS

FIG. 1 shows a system in accordance with one or more embodiments of the invention.

FIGS. 2A-2B show systems in accordance with one or more embodiments of the invention.

FIG. 3 shows a flow diagram in accordance with one or more embodiments of the invention.

FIGS. 4A-4B shows a flow diagram in accordance with one or more embodiments of the invention.

FIGS. 5A-5F show an example in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for obtaining targeted advertising without submitting data to advertisers specific to the user. Specifically, embodiments of the invention may be used to obtain general advertisements related to a general user interest, and present the user with a subset of those advertisements more targeted to the user's tastes.

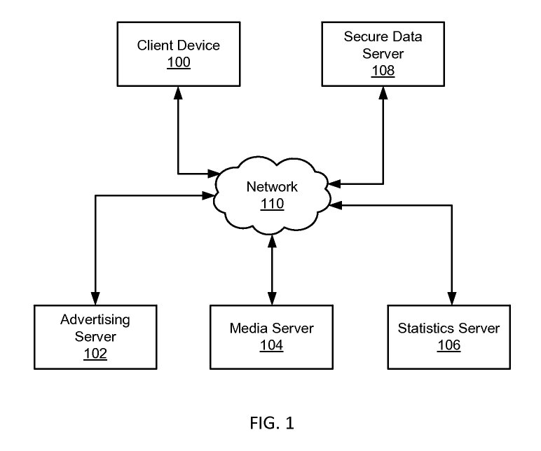

FIG. 1 shows a diagram of a system in accordance with one or more embodiments of the invention. As shown in FIG. 1, a client device (100) is connected to an advertising server (102), a media server (104), statistics server (106), and a secure data server (108) via a network (110).

In one or more embodiments of the invention, the client device (100) is communicatively coupled to the advertising server (102), the media server (104), the statistics server (106), and/or the secure data server (108). This communicative coupling may be accomplished, for example, over a computer network (e.g., the network (110)).

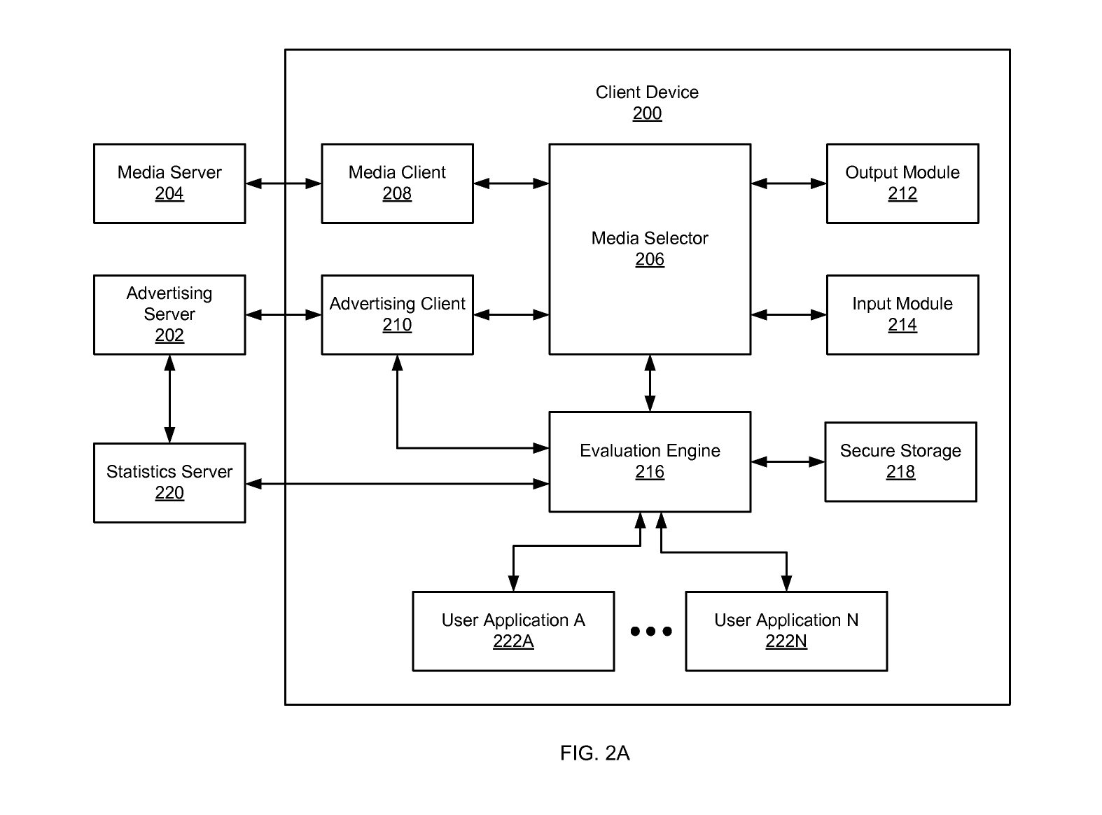

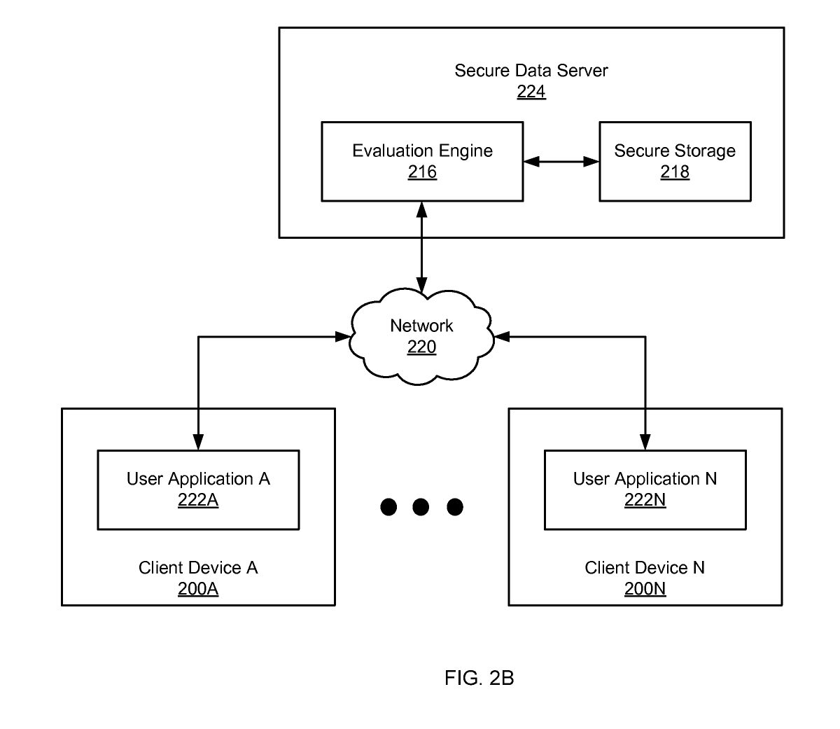

In one or more embodiments of the invention, the client device (100) is a computer system configured to interact with the advertising server (102), the media server (104), the statistics server (106), and the secure data server (108) over the network (110). Specifically, the client device (102) may be a physical computer system that includes a processor, volatile memory, persistent memory, an output device, and an input device. The client device (102) may be implemented as a personal computer or computing device operated by a user such as, for example, a smartphone, a laptop computer, a smart television, a smart appliance, a tablet computer, and/or any user device that is capable of interacting over a network connection such as the network (110). Detail about the client device (100) is provided below in FIGS. 2A-2B.

In one or more embodiments of the invention, the advertising server (102) is a computer system or group of computer systems configured to service requests from the client device (100) for sets of advertisements. Specifically, the advertising server (102) may include a repository of advertisements organized into groups or sets of related advertisements. Such advertisements may include various advertisement media such as, for example, image files, video files, text files, audio files, and interactive media files. Further, groups of advertisements may be provided to a client device in response to a request for a group of advertisements related to a particular subject.

In one or more embodiments of the invention, the media server (104) is a computer system or group of computer systems configured to provide media items to client device (100). Specifically, the media server (104) is configured to received requests for media items from client device (100), and provide media items to the client device (100) based on the request. Such media items may include, for example, image files, video files, text files, audio files, and interactive media files. Media item content may include content related to news stories, entertainment information, narrative fiction, and user friend updates. In one embodiment of the invention, the advertising server (102) and the media server (104) are implemented in the same server.

In one or more embodiments of the invention, the statistics server (106) is a computer system or group of computer systems configured to obtain information about user interactions with advertisements from client device (100), and provide that information, in aggregated form, to advertising server. Further information about the statistics server is discussed in FIG. 2A.

In one or more embodiments of the invention, the secure data server (108) is a computer system or group of computer systems configured to interact with client device (100) to obtain and provide media subcategories and other information from and to client device (100). Further information about the secure data server (108) is provided in FIG. 2B.

FIG. 2A shows a client device in accordance with one or more embodiments of the invention. As shown in FIG. 2A, the client device (200) is connected to an advertising server (202), a media server (204), and a statistics server (220). The client device (200) includes a media selector (206), a media client (208), an advertising client (210), an output module (212), an input module (214), an evaluation engine (216) secure storage (218), and user applications (user application A (222A), user application N (222N)).

In one or more embodiments of the invention, one or more of the elements depicted in FIG. 2A may be embodied in a user application (such as user applications (user application A (222A), user application N (222N)). In one embodiment of the invention, the media selector and media client may be implemented in a single user application. In one embodiment of the invention, the advertising client may be implemented in a user application. Each user application may be configured to interact with the evaluation engine (216). Specifically, each user application (including media client (208), media selector (206), advertising client (210), combinations of these elements, and user applications (user application A (222A), user application N (222N))) may submit information about a user or may request information about a user to the evaluation engine (216).

In one or more embodiments of the invention, the media selector (206) is a process or group of processes configured to obtain media items from the media client (208) and advertisements from the advertising client (210). In one embodiment of the invention, the media selector (206) is further configured to select media items and advertisements for presentation to a user via the output module (212). In one embodiment of the invention, the media items and advertisements are selected based on instructions from the evaluation engine (216). In one embodiment of the invention, the media selector (206) is configured to present media items and advertisements to the user in the order they are received unless otherwise instructed by the evaluation engine (216).

In one or more embodiments of the invention, the media selector (206) is configured to obtain user interactions from the input module (214) and provide those user interactions to the evaluation engine (216). In one embodiment of the invention, each user interaction is associated with a media item. In one embodiment of the invention, both the user interaction and the media item (or media item identifier) are provided to the evaluation engine.

In one or more embodiments of the invention, the media client (208) is a process or group of processes configured to interact with media server (204). Specifically, the media client (208) is configured to generate requests for media items and transmit those requests to the media server (204). Further, the media client (208) may also be configured to received media items from the media server (204) and provide those media items to the media selector (206). In one embodiment of the invention, the media client (208) is configured to authenticate the client device to the media server (204).

In one or more embodiments of the invention, the advertising client (210) is a process or group of processes configured to interact with advertising server (202). Specifically, the advertising client (210) is configured to generate requests for advertisements or sets of advertisements and transmit those requests to the advertising server (202). Further, the advertising client (210) may also be configured to received advertisements from the advertising server (202) and provide those advertisements to the media selector (206). In one embodiment of the invention, the advertising client (210) is configured to authenticate the client device to the advertising server (202).

In one or more embodiments of the invention, the output module (212) is a process or group of processes configured to present media items and advertisements to a user via a physical output device. In one embodiment of the invention, the output module (212) is an intermediary process or set of processes between the media selector (206) and the physical output device or devices of the client device (200). Output module (212) may include, for example, a display driver for a physical display and/or an audio driver for a speaker.

In one or more embodiments of the invention, the input module (214) is a process or group of processes configured to obtain user interactions from a physical input device and provide those user interactions to the media selector (206). In one embodiment of the invention, the input module (214) is an intermediary process or set of processes between a physical input device and the media selector. Input module (214) may include, for example, a driver for a touch screen and/or a driver for physical buttons on the client device (200).

In one or more embodiments of the invention, the evaluation engine (216) is a process or group of processes configured to evaluate the user interactions with the media items, store user impressions, and determine subcategories and categories associated with the media items. In one embodiment of the invention, the evaluation engine is further configured to instruct the media selector (206) regarding which of a set of advertisements and media items should be presented to the user. Further, the evaluation engine may be configured to instruct the advertising client regarding requests for advertisements. Such requests may include requests for data and files, such as webpages.

In one or more embodiments of the invention, the secure storage (218) is an interface by which the evaluation engine (216) stores media items (or media item identifiers) media item attributes, user impressions, media subcategories, and media categories. In one embodiment of the invention, one or more of the aforementioned elements may be stored in an encrypted form using the secure storage (218).

In one or more embodiments of the invention, the statistics server (220) is a computer system or group of computer systems configured to store information about a user's interactions with advertisements from the advertisement server (202). In one embodiment of the invention, advertisers using the advertisement server (202) to provide ads to client device (200) may require information regarding whether the user interacted (e.g., selected, clicked on, etc.) with the advertisement that was displayed. In one embodiment of the invention, the evaluation engine collects advertisement interaction data about user interactions with the presented advertisements, and provides that data to the statistics server (220). In one embodiment of the invention, the advertisement interaction data is sent to the statistics server (220) via a secure (i.e., encrypted) connection.

In one or more embodiments of the invention, the advertisement interaction data is aggregated by the statistics server (220), and provided to the advertisement server (202) in an aggregated format. In one embodiment of the invention, providing the advertisement interaction data in an aggregated format prevents the advertisement server (202) from access to the specific advertisement interaction data of a specific user of the client device (200).

In one or more embodiments of the invention, submissions and requests between user applications (including media client (208), media selector (206), advertising client (210), combinations of these elements, and user applications (user application A (222A), user application N (222N))) and the evaluation engine (216) may be accompanied by identifying information about the user and/or authentication information. Further, the evaluation engine (216) may be configured to allow or deny the request based on the identifying information, authentication information, and/or the source of the submission or request. Specifically, the evaluation engine (216) may respond differently to similar requests by different user applications. For example, a request for a media subcategory from the advertising client (210) may be denied or, alternatively, the request response may be a media category. Continuing with the example, an authenticated request from a user application for a media subcategory may be serviced by the evaluation engine (216) providing the media subcategory.

In one or more embodiments of the invention, the client device (200) may be configured to interact with multiple users. Further, the evaluation engine (216) and the secure storage (218) may be configured to store the media items (or media item identifiers) media item attributes, user impressions, media subcategories, and media categories for a group of users. In one embodiment of the invention, the client device (200) may associated an identity with each user of the client device, and the media items, media item attributes, user impressions, media subcategories, and media categories for each user may be associated with the identify for that user.

As a non-limiting example, consider the following. A smart appliance such as a refrigerator with an interactive display (client device (200)) may be used by different members of the same household. The refrigerator may have a user identity associated with the household as a single entity or each member of the household as separate entities, and prior to interacting with the interactive display, the user must identify themselves to the refrigerator either once for the entire household or each member of the household separately. Based on the identification, the media items, media item attributes, user impressions, media subcategories, and media categories for that user may be used by the evaluation engine (216) and other elements on the client device (200) during the interaction with that user.

In one or more embodiments of the invention, the evaluation engine (216) is configured to interact with other user applications (e.g. user application A (222A), user application N (222N)) on the client device (200). In one embodiment of the invention, the evaluation engine (216), the secure storage (218), the media selector (206), the media client (208), and/or the advertising client (210) may be embodied in a single user application. Such a user application may be configured to interact with other user applications (e.g. user application A (222A), user application N (222N)) on the client device (200).

In one or more embodiments of the invention, the topology described in FIG. 2A may be utilized where the media subcategories and other information about a user of the client device (200) are stored locally on the client device (200). Such information may be accessible by other user applications (e.g. user application A (222A), user application N (222N)) executing on the client device (200) via an interface (e.g., an application programming interface defined by the evaluation engine (216)).

In one or more embodiments of the invention, the evaluation engine (216) is configured to interact with the user applications (e.g. user application A (222A), user application N (222N)) to obtain media items, media item attributes, user impressions, and media subcategories from the user applications (e.g. user application A (222A), user application N (222N)). In one embodiment of the invention, the user application (e.g. user application A (222A), user application N (222N)) may gather media items, media item attributes, user impressions, and media subcategories for a user and submit those media items, media item attributes, user impressions, and media subcategories to the evaluation engine (216) for storage via the secure storage (218).

In one or more embodiments of the invention, the evaluation engine (216) is configured to interact with the user applications (e.g. user application A (222A), user application N (222N)) to provide media attributes (i.e., a preference) for a media category provided by the user applications (e.g. user application A (222A), user application N (222N)). In one embodiment of the invention, the user application (e.g. user application A (222A), user application N (222N)) may submit a query to the evaluation engine (216) containing a category and some form of authorization. In response to the query, the evaluation engine (216) may then authenticate the user application (e.g. user application A (222A), user application N (222N)), and provide query results that include a subcategory preference for the submitted category.

As a non-limiting example, consider the following. Based on previous user interactions, the evaluation engine (216) may have determined that the user of the client device (200) has a preference for Thai food. That subcategory preference may be stored via the secured storage (218). A restaurant recommendation application (e.g. user application A (222A), user application N (222N)) on the client device (200) may be directed to providing restaurant recommendations to the user. The restaurant recommendation application may then request authorization from the user to access media subcategories preferences on the secured storage. The restaurant recommendation application may then submit, to the evaluation engine (216), a request for media subcategories for the category of food. Once authenticated, the evaluation engine (216) may then respond to the restaurant recommendation application with the subcategory preference of Thai food.

FIG. 2B shows a client device and secure data server in accordance with one or more embodiments of the invention. Specifically, FIG. 2B shows an alternative topology (i.e. client-server topology) to that which is depicted in FIG. 2A. As shown in FIG. 2B, a secure data server (224) includes an evaluation engine (216) and a secure storage (218). The secure data server (224) is connected (e.g., over a network like the Internet) to various client devices (e.g. client device A (200A), client device N (200N)). Each client device includes one or more user applications (e.g. user application A (222A), user application N (222N)).

In one or more embodiments of the invention, the topology described in FIG. 2B may be utilized where a single user accesses multiple devices (e.g., client device A (200A), client device N (200N)), and the media subcategories and other information about that user is stored in a single location (e.g., secure data server (224)). The system may include other elements, such as those elements depicted in FIG. 2A, not shown in FIG. 2B.

In one or more embodiments of the invention, the secure data server (224) is a computer system or group of computer systems configured to host the evaluation engine (216) and the secure storage (218). In one or more embodiments of the invention, the evaluation engine (216) is configured to interact with one or more user applications (e.g. user application A (222A), user application N (222N)) and client devices (e.g. client device A (200A), client device N (200N)) to obtain media items, media item attributes, user impressions, and media subcategories from the user applications (e.g. user application A (222A), user application N (222N)). In one embodiment of the invention, the user application (e.g. user application A (222A), user application N (222N)) gathers media items, media item attributes, user impressions, and media subcategories for a user and submit those media items, media item attributes, user impressions, and media subcategories to the evaluation engine (216) for storage via the secure storage (218). In one embodiment of the invention, the media items, media item attributes, user impressions, and media subcategories for a user are transmitted to the secure data server (224) via a secure (i.e., encrypted) connection.

In one or more embodiments of the invention, the secure data server (224) is configured to service requests for media subcategories from one or more user applications (e.g. user application A (222A), user application N (222N)) on one or more client devices (e.g. client device A (200A), client device N (200N)). In one embodiment of the invention, the user application (e.g. user application A (222A), user application N (222N)) submits a query to the evaluation engine (216) containing a category and some form of authorization to access a user's data. In response to the query, evaluation engine (216) may then authenticate the client device (e.g. client device A (200A), client device N (200N)) and/or the user application (e.g. user application A (222A), user application N (222N)), and provide query results that include a media subcategory for the submitted category.

As a non-limiting example, consider the following. A user may have a user application in the form of a automobile driving monitor application executing on a computer system such as a client device (e.g. client device A (200A), client device N (200N)) located within the user's automobile. The user may log into the driving monitor application using credentials associated with their user identity stored on the secure data server (224). The driving monitor application may then gather driving data indicating that the user likes to (or tends to) drive fast (i.e. driving at a speed over the speed limit). The driving monitor application may submit this data as media attributes, along with the user credentials, to the secure data server (224). The user would not want this information made generally available, as it could lead to legal consequences. Therefore, the information is stored securely on the secured storage (218) accessible only via the evaluation engine (216).

Continuing with the example, suppose that the driving monitor application includes functionality to request advertisements to display to the driver. The driving monitor application may obtain a set of advertisements from an advertising server. The driving monitor application may also request a media subcategory from the evaluation engine (216). The evaluation engine (216) may provide the driving monitor application with a media subcategory indicating that the user is prone to speeding. The driving application may then filter the received set of advertisements, selecting only those targeted to fast drivers (e.g., car insurance, race events, high performance car parts, etc.).

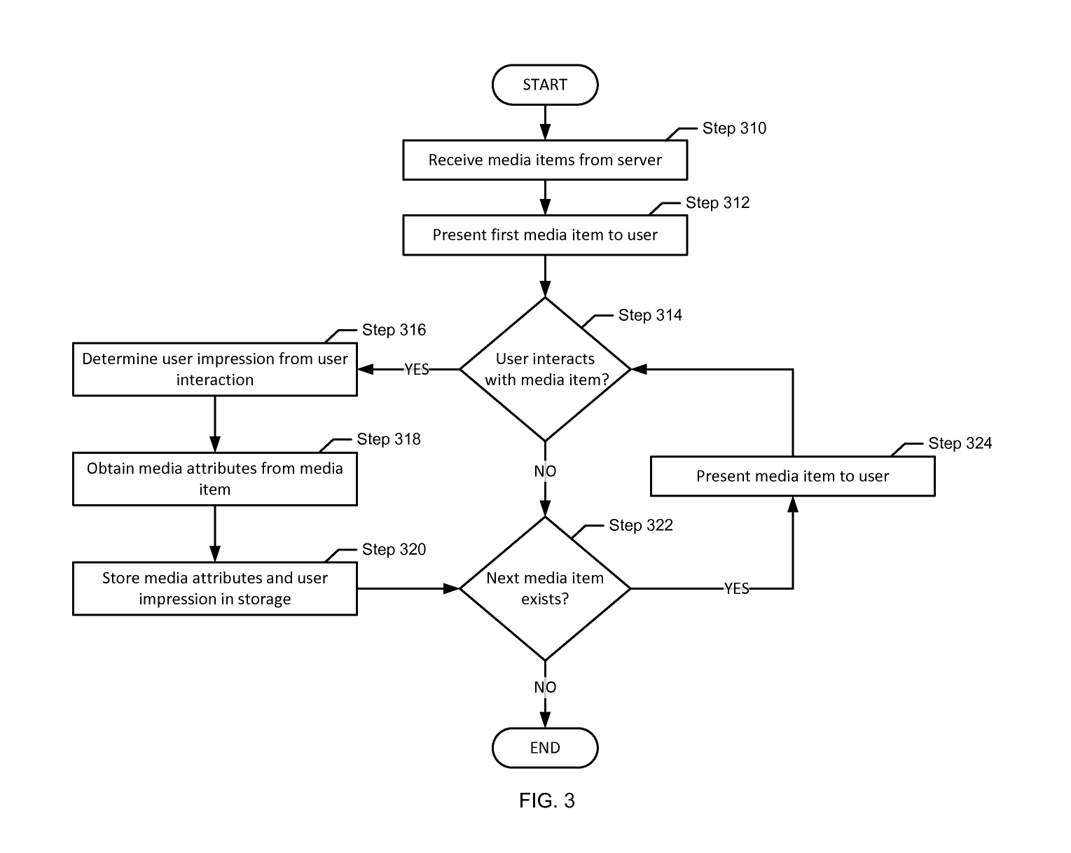

FIG. 3 shows a flowchart for obtaining user impressions in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel.

In Step 310, the client device receives media items from a media server. In one embodiment of the invention, the media items are received in response to a request for media items from the client device. In one embodiment of the invention, the media items are received in a group or set of media items. The set of media items may be the most recently generated media items, or may represent the media items generated since the previous set of media items was sent to the client device.

In Step 312, the first media item is presented to the user. In one embodiment of the invention, the media selector selects a media item to be presented and presents the media item to the user via the output module. In one embodiment of the invention, the media item presents media items to the user based on input from the evaluation engine. For example, the evaluation engine may instruct the media selector to present media items related to a certain subject before presenting media items that do not relate to that subject.

In Step 314, the media selector determines whether the user interacts with the media item. In one embodiment of the invention, user interactions are obtained via the output module. User interactions may include, for example, the activation of a “like” or “dislike” button by the user, time the user spends reading the media item, whether the media item is stored by the user for later reference, whether the media item is shared with other users, and whether the media item is immediately deleted by the user. In one embodiment of the invention, user interactions are used to determine a user impression related to the media item.

In Step 316, the client device determines the user impression from the user interactions with the media item. User may include direct user impressions and indirect user impressions. In one embodiment of the invention, a direct user impression is user input received by the media selector expressing the user's feelings regarding the media item. Direct user impressions include, for example, the activation of a “like” or “dislike” button associated with the media item. In one embodiment of the invention, there are positive direct user impressions (indicating the user feels positively about the media item) and negative direct user impressions (indicating that the user feels negatively about the media item).

In one embodiment of the invention, an indirect user impression is user input monitored by the media selector directed to a media item. Indirect user impressions include, for example, whether a media item is selected by a user, time spent by a user reading or interacting with the media item, whether the user shares the item with other users, and whether the user immediately deletes the media item. In one embodiment of the invention, there are positive indirect user impressions (indications that the user feels positively about the media item) and negative indirect user impressions (indications that the user feels negatively about the media item).

In Step 318, the media attributes are obtained from the media item. In one embodiment of the invention, the media attributes of a media item are the characteristics of the content of the media item. Media attributes may include, for example, subject matter of the media item, tone of the media time, textual makeup of the media item, and types of words, sounds, or images used in the media item. As a specific example, if a media item is a brief news update with a link about a new car made by company A, then the media attributes may include the attributes “car,” “company A,” “new car,” “brief news updates,” and “linked news updates.” In Step 320, the evaluation engine stores the media attributes and the user impression for the media item in storage.

In Step 322, the media selector determines whether there is another media item to present to the user. If in Step 322, the media selector determines that there is a new media item to present to the user, then in Step 324, the new media item is presented to the user.

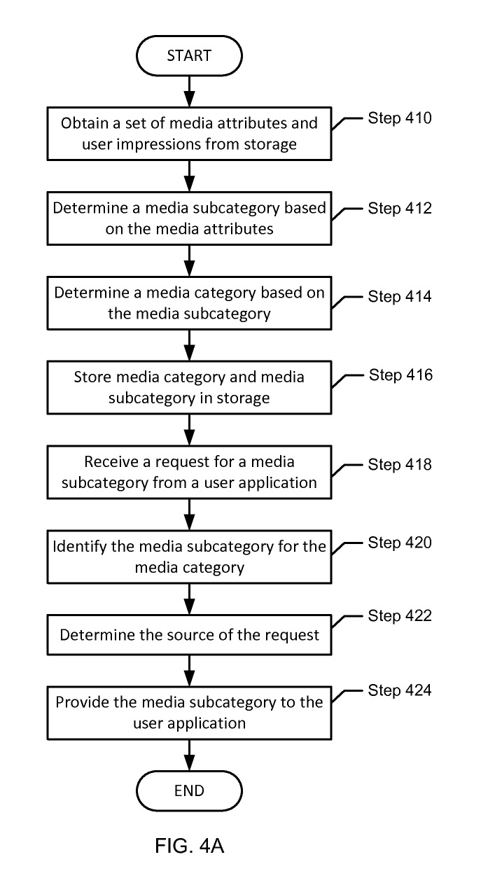

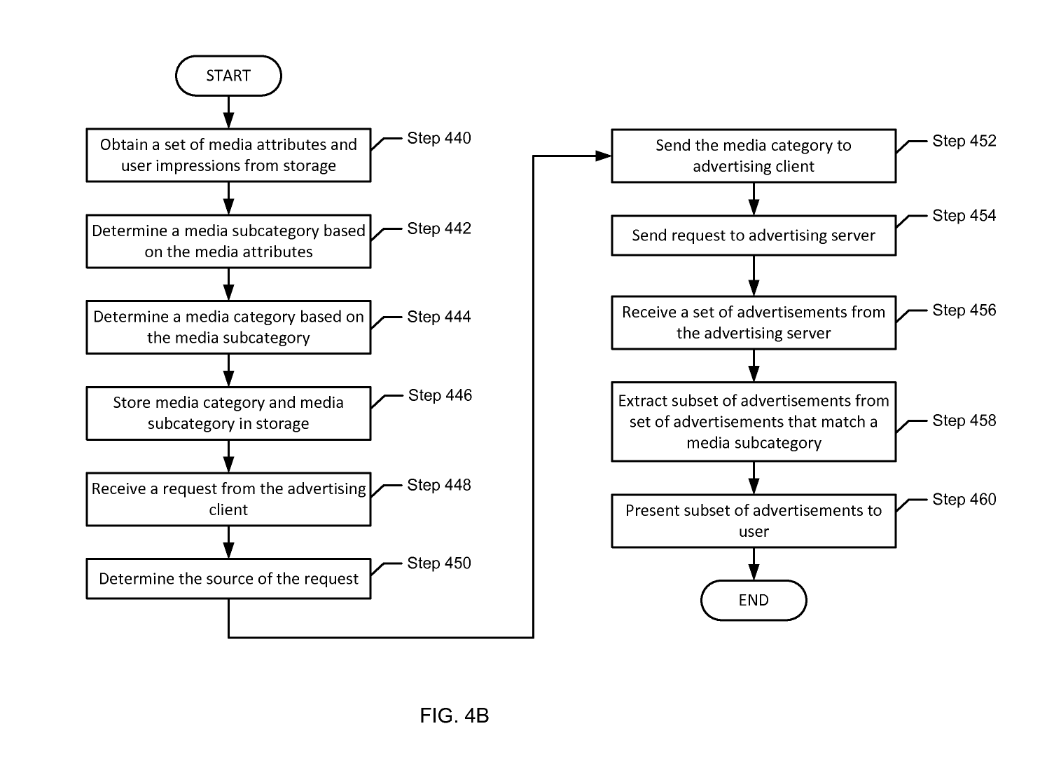

FIG. 4A shows a flowchart for proving a media subcategory to a user application in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel.

In Step 410, the evaluation engine obtains a set of media attributes and user impressions from storage. In one embodiment of the invention, the evaluation engine may evaluate the content of the stored media attributes and user impressions to determine the media attributes associated with a positive user impression. In one embodiment of the invention, the set of media attributes may be those media attributes associated with positive user impressions. In one embodiment of the invention, the obtained set of media attributes are those media attributes with the most user impressions associated with them (both positive and negative). In one embodiment of the invention, the obtained set of media attributes are those media attributes that have a threshold number of user impressions associated with them.

In Step 412, the evaluation engine determines a media subcategory for each media item based on the media attributes. In one embodiment of the invention, the media subcategory is a characteristic of a group of media attributes. For example, each media item related to news stories about different cars made by Company A may have a media subcategory of “cars made by Company A.”

In Step 414, the evaluation engine determines a media category based on the media subcategory. In one embodiment of the invention, the media category is a general characteristic associated with the narrower media subcategory. For example, a set of media attributes with a media subcategory of “cars made by Company A” may have a media category of “cars.” As used herein, a media subcategory indicates more specificity than a media category. In one embodiment of the invention, the evaluation engine determines the media category by matching the media subcategory to a limited number of media categories.

In Step 416, the evaluation engine stores the media category and the media subcategory in storage. In one embodiment of the invention, the media category and media subcategory are stored securely in an encrypted form. In one embodiment of the invention, each set of attributes for a media item is associated with a media subcategory and a media category.

In Step 418, the evaluation engine receives a request for a media subcategory from a user application. In one embodiment of the invention, the request includes a media category for which the media subcategory is requested. In one embodiment of the invention, the request includes authentication data (e.g., a password, encrypted text, etc.) used by the evaluation engine to verify that the user application is authorized to receive the media subcategory.

In Step 420, the evaluation engine identifies the media subcategory for the media category submitted in the request. In Step 422, the evaluation engine determines the source of the request. In one embodiment of the invention, the response may vary depending upon the requesting user application. For example, a request from a user application associated with advertising purposes may only be allowed access to media categories. Alternatively, a user application associated with recommending restaurants to the user may be granted access to the media subcategory. In one embodiment of the invention, the evaluation engine is configured to track user applications that the user has granted permission to access media subcategories, media attributes, and other information about the user gathered by the evaluation engine.

In Step 424, the evaluation engine provides the media subcategory to the user application. In one embodiment of the invention, the evaluation engine with provide the media subcategory to the user application only if the user application has been authenticated or granted permission by the user. In one embodiment of the invention, the evaluation engine provides only the user information for which the requesting user application has been authorized to obtain.

FIG. 4B shows a flowchart for obtaining a set of advertisements in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel.

Specifically, FIG. 4B shows the process of FIG. 4A when the requesting user application is an advertising client. The user application may include other elements along with the advertising client.

In Step 440, the evaluation engine obtains a set of media attributes and user impressions from storage. In Step 442, the evaluation engine determines a media subcategory for each media item based on the media attributes. In Step 444, the evaluation engine determines a media category based on the media subcategory. In Step 446, the evaluation engine stores the media category and the media subcategory in storage.

In Step 448, the evaluation engine receives a request for a media subcategory from the advertising client. In one embodiment of the invention, the evaluation engine determines which media category to submit to the advertising client based on the number of media items interacted with by a user that are of the media category. In one embodiment of the invention, the media category or categories submitted to the advertising client is based on a threshold number of media items interacted with by a user that are of the media category. In one embodiment of the invention, the evaluation engine submits a set number of categories to the advertising client based on the media categories with the highest number of media items interacted with by a user that are of the media category.

In Step 452, the evaluation engine sends the media category to the advertising client. In Step 454, the advertising client sends an advertising request to the advertising server. In one embodiment of the invention, the advertising request is generated using only the media category and excludes the media subcategory. The advertising request may further exclude any detail about the media item or media attributes of the media items with which the user has interacted. In one embodiment of the invention, the advertising client is unable to access any detail about the media item or media attributes of the media items stored in the storage.

In Step 456, the advertising client receives a set of advertisements from the advertising server in response to the advertising request. In one embodiment of the invention, the set of advertisements includes advertisements related to the media category. In Step 458, the evaluation engine instructs the media selector to extract, from the subset of advertisements, advertisements related to the media subcategory. In one embodiment of the invention, the set of advertisements received by the media selector from the advertising client includes advertisements unrelated to the media subcategory associated with the media category that was used to generate the advertising request. In one embodiment of the invention, advertisements unrelated to the media subcategory are discarded by the media selector. In one embodiment of the invention, advertisements are extracted for use based on multiple subcategories (e.g., subcategories associated with media items with a high rate of user interactivity).

For example, a set of advertisements may be received in response to a request for advertisements related to pets, which may be a category determined from the subcategory of “dogs.” The evaluation engine may have also determined that the user has interacted positively with media items associated with a subcategory of “cars made by Company A.” In this case, the evaluation engine may instruct the media selector to extract all advertisements related to dogs, as well as all advertisements related to cars made by Company A.

In Step 460, the media selector presents the extracted advertisements to the user. In one embodiment of the invention, the extracted advertisements are presented via the output module in the same manner as the media items are presented to the user.

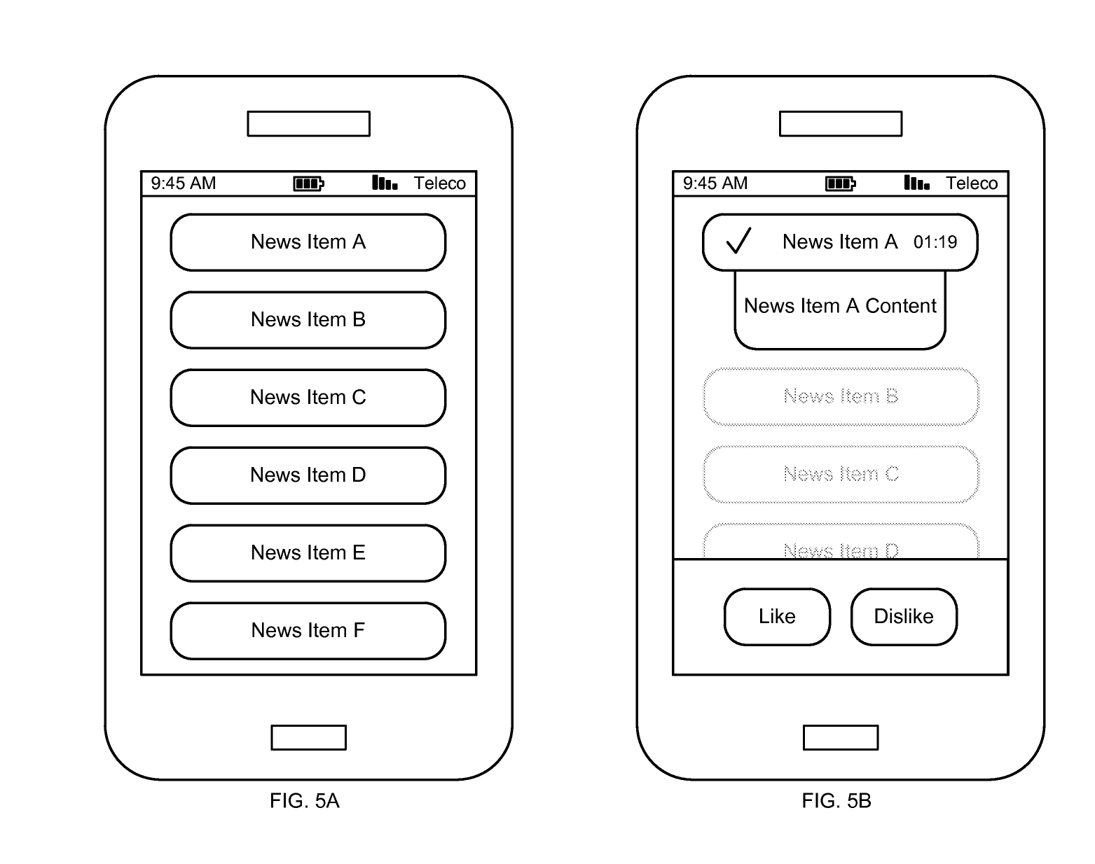

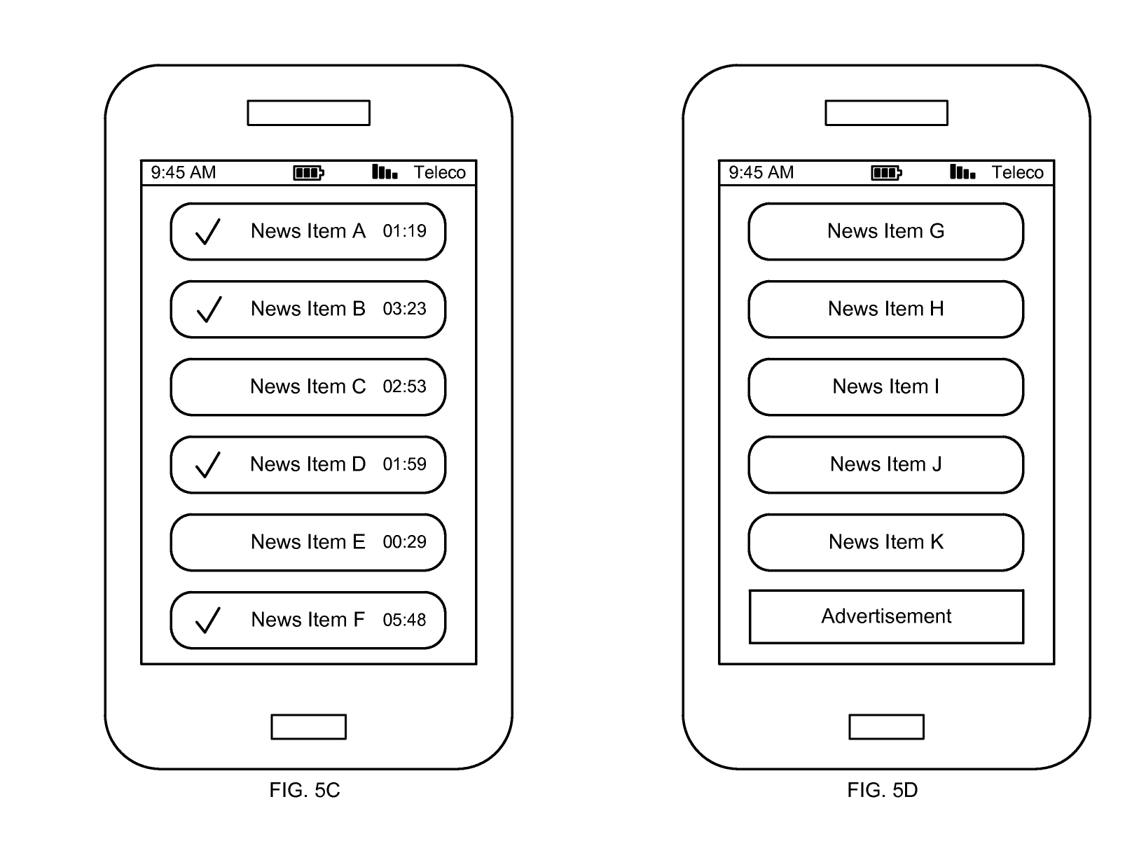

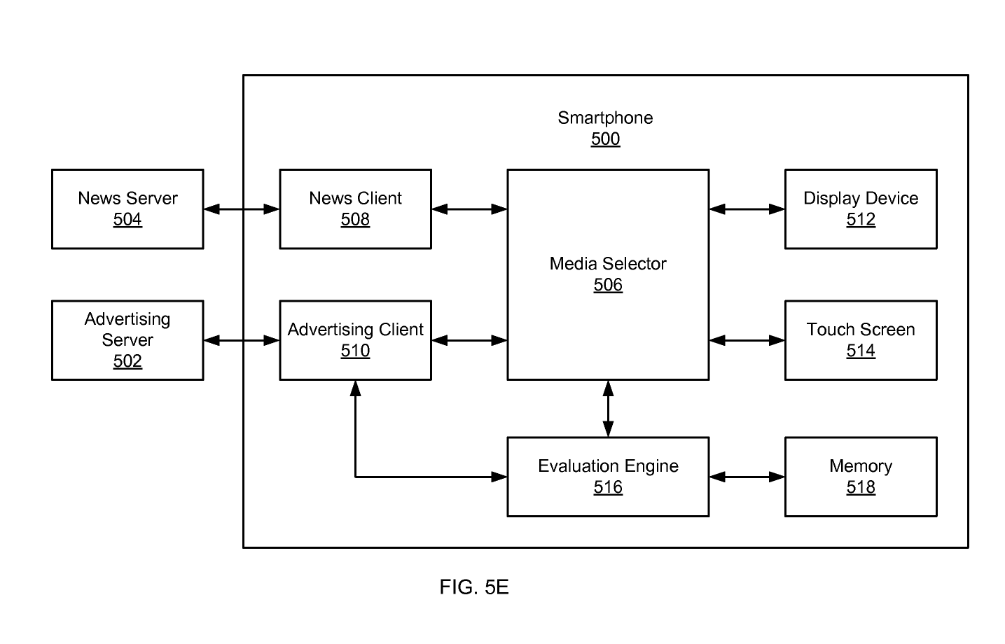

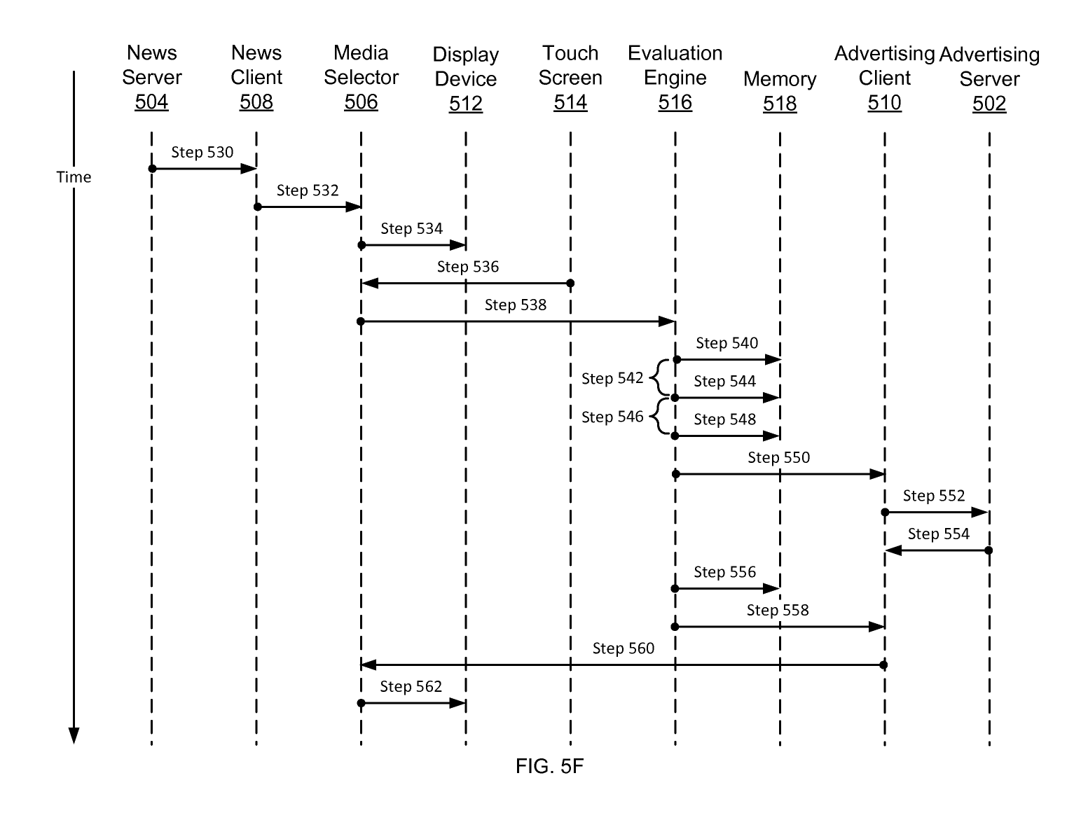

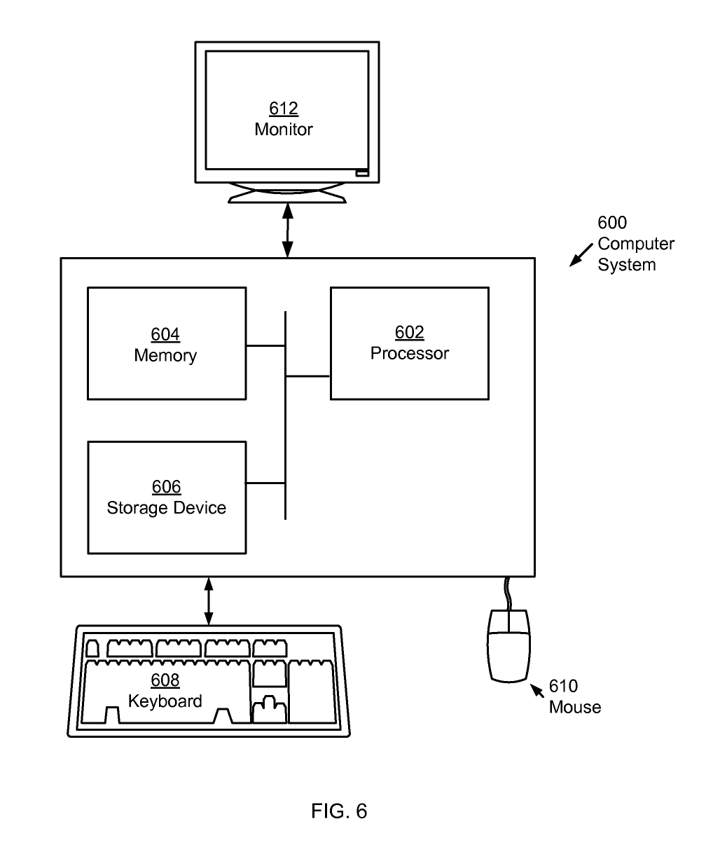

FIGS. 5A-5F show an example in accordance with one or more embodiments of the invention. As shown in FIG. 5A, a smartphone includes multiple news items (news item A, news item B, news item C, news item D, news item E, news item F). FIG. 5B shows the user interacting with news item A. The user has indicated that the user “likes” news item A (indicated by a check mark). Also, the time the user has spent reading news item A content is monitored.

FIG. 5C shows the smartphone display once the user has interacted with each news item. News item A, news item B, news item D, and news item F have been marked with a check to indicate that the user likes those news items (i.e., a positive direct user impression). Further, FIG. 5C also shows a time associated with each news item indicating the amount of time the user spent reading that news item. FIG. 5B shows the same smartphone at a later point in time presenting the user with five unread news items and an advertisement.

FIG. 5E shows the relationship between the elements within the smartphone depicted in FIGS. 5A-5D. As shown in FIG. 5E, the smartphone (500) is connected to an advertising server (502) and a news server (504). The smartphone (500) includes a media selector (506), a news client (508), an advertising client (510), a display device (512), a touch screen (514), an evaluation engine (516) and memory (518).

FIG. 5F shows an example timeline showing the process of transitioning from the state of the smartphone depicted in FIG. 5A, to the state of the smartphone depicted in FIG. 5B. Specifically, the timeline shows the process of determining an advertisement to present to the user in FIG. 5B based on the user's interaction with the news items in FIG. 5A.

In Step 530, the news server (504) sends news item A, news item B, news item

C, news item D, news item E, and news item F to news client (508). In Step 532, news client (508) sends the news items to the media selector (506). In Step 534, the media selector (506) presents the news items to the user via the display device (512). FIG. 5A depicts the smartphone state after Step 534 has been performed. In Step 536, the media selector (506) receives user interactions from the touch screen (514) for each of the presented news items. FIG. 5C depicts the smartphone state after Step 536 has been performed.

In Step 538, the media selector (506) sends the user interactions and media attributes for each news item to the evaluation engine (516). In Step 540, the evaluation engine (516) stores the user interactions and media attributes for each news item in the memory (518). At Step 542, the evaluation engine (516) determines user impressions based on the user interactions. In the example depicted in FIG. 5C, each news item is associated with two user interactions. News item A, news item B, news item D, and news item F have been marked with a check to indicate that the user likes those news items. The evaluation engine (516) interprets this user interaction as a positive direct user impression.

Continuing with Step 542, the evaluation engine (516) also interprets the time spent interacting with each news item into a user impression. For the purposes of this example assume that an interaction time greater than two minutes indicates a positive (indirect) user impression, and an interaction time less than two minutes indicates a negative (indirect) user impression. Therefore, the evaluation engine (516) would associated a positive user impression with news item B, news item C, and news item F, and a negative user impression with news item A, news item D, and news item E. At Step 544, the evaluation engine (516) stores the direct user impressions and the indirect user impressions in the memory (518).

In Step 546, the evaluation engine (516) determines a subcategory and category for each set of media attributes associated with each news item. For the purposes of the example, assume the following: news item A is an article discussing the housing market, news item B is a review of a sports car made by Company A, news item C is a political story, news item D is an offer to purchase high-end headphones at a reduced rate, news story E is a how-to for building a desk, and news story F is a video of a sports car made by Company B.

Based on the media attributes of each news item, the evaluation engine (516) determines the subcategories as follows: news item A has a subcategory of housing market, news item B has a subcategory of sports cars made by Company A, news item C has a subcategory of political stories, news item D has a subcategory of high-end headphones, news story E has a subcategory of how-tos for furniture, and news story F has a subcategory of sports cars made by Company B.

Based on the subcategories of each news item, the evaluation engine (516) determines the categories as follows: news item A has a category of real estate, news item B has a category of cars, news item C has a category of government, news item D has a category of consumer electronics, news story E has a category of do-it-yourself, and news story F has a category of cars. In Step 548, the evaluation engine (516) stores the subcategory and category in memory (518).

Assume that the evaluation engine (516) operates under a policy where advertisements are requested based on news items which have two positive impressions expressed by a user. In this example, the evaluation engine (516) determines that news item B and news item F both have two positive user impressions associated with them. Based on this determination, in Step 550, the evaluation engine (516) instructs the advertising client (510) to request advertisements using the category for news item B and news item F, both of which are “cars.”

In Step 552, the advertising client (510) generates the request for a set of advertisements related to cars, and sends the request to the advertising server (502). In Step 554, the advertising server (502) sends a set of advertisements related to cars to the advertising client (510). At Step 556, the evaluation engine (516) obtains the subcategory for the category submitted to the advertising client (510) from memory (518). At Step 558, the evaluation engine (516) instructs the advertising client (510) to extract advertisements related to sports cars from the set of advertisements received from the advertising server (502).

At Step 560, the extracted advertisements related to sports cars is provided to the media selector (506). At Step 562, the media selector (506) presents one of the advertisements related to sports cars to the user via the display device (512). FIG. 5D depicts the smartphone displaying the advertisement along with a new set of news items.

Embodiments of the invention may be implemented on virtually any type of computer regardless of the platform being used. For example, as shown in FIG. 13, a computer system (600) includes one or more computer processor(s) (602) such as a central processing unit (CPU) or other hardware processor(s), associated memory (604) (e.g., random access memory (RAM), cache memory, flash memory, etc.), a storage device (606) (e.g., a hard disk, an optical drive such as a compact disk drive or digital video disk (DVD) drive, a flash memory stick, etc.), and numerous other elements and functionalities typical of today's computers (not shown). In one or more embodiments of the invention, the processor (602) is hardware. For example, the processor may be an integrated circuit. The computer system (600) may also include input means, such as a keyboard (608), a mouse (610), or a microphone (not shown). Further, the computer system (600) may include output means, such as a monitor (612) (e.g., a liquid crystal display (LCD), a plasma display, or cathode ray tube (CRT) monitor). The computer system (600) may be connected to a network (614) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the invention.

Further, those skilled in the art will appreciate that one or more elements of the aforementioned computer system (600) may be located at a remote location and connected to the other elements over a network. Further, embodiments of the invention may be implemented on a distributed system having a plurality of nodes, where each portion of the invention (e.g., user agreement information, product use agreement pre-recordings, application store, product use agreement application, etc.) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A system comprising:
an evaluation engine, executing on a client device, configured to:
obtain a plurality of media attributes of a plurality of media items associated with a user;
determine a media category and a media subcategory based on the plurality of attributes, wherein the media category comprises the media subcategory;
receive, from a user application on the client device, a request for the media subcategory, wherein the request comprises the media category;
identify, in response to the request, the media subcategory associated with the media category;
determine a source of the request; and
provide, to the client device, the media subcategory for the media category based on the source of the request;
a secure storage configured to:
store the media subcategory for access and identification by the evaluation engine; and
an advertising client, executing on the client device, configured to:
obtain, from the evaluation engine, the media category;
generate an advertising request comprising the media category and excluding the media subcategory; and
submit, to an advertising server, the advertising request.

2. The system of claim 1, wherein the user application is configured to:
generate the request for the media subcategory, wherein the request comprises authentication data.

3. The system of claim 1, further comprising:
a media selector configured to:
provide the plurality of media attributes to the evaluation engine.

4. (canceled)

5. The system of claim 1, wherein the evaluation engine, secure storage, a user application, a media selector, and an advertising client reside on the client device.

6. The system of claim 1, further comprising:
a secure data server configured to receive requests from the client device, wherein the evaluation engine and the secure storage reside on the secure data server.

7. The system of claim 6, wherein the secure data server and the client device are communicatively coupled via a network.

8. The system of claim 1,
wherein the advertising client is implemented in the user application residing on the client device.

9. The system of claim 1, wherein the client device comprises a processor, volatile memory, persistent memory, an output device, and an input device.

10. A method for tracking a user's preferences comprising:
obtaining a plurality of attributes of a plurality of media items associated with the user;
determining, by an evaluation engine executing on a computer processor of a client device, a media category and a media subcategory based on the plurality of attributes, wherein the media category comprises the media subcategory;
receiving, from a user application on the client device, a request for the media subcategory, wherein the request comprises the media category;
identifying, by the evaluation engine in response to the request, the media subcategory associated with the media category;
providing, to the user application, the media subcategory for the media category;
obtaining, by an advertising client executing on the client device, the media category;
generating, by the advertising client, an advertising request comprising the media category and excluding the media subcategory; and
submitting, by the advertising client, the advertising request to an advertising server.

11. The method of claim 10, wherein obtaining the plurality of attributes of the plurality of media items associated with the user comprises:
receiving a plurality of media items from a media server;
determining a subset of the plurality of media items viewed by the user;
identifying, by an evaluation engine, a plurality of media attributes shared by the subset of the plurality of media items.

12. The method of claim 11, wherein determining the subset of the plurality of media items associated with the user comprises determining an amount of time the user spends interacting with each of the subset of the plurality of media items.

13. The method of claim 11, wherein determining the subset of the plurality of media items viewed by the user comprises receiving a direct user impression for each of the subset of the plurality of media items.

14. The method of claim 11, wherein determining the subset of the plurality of media items viewed by the user comprises:
receiving an indirect user impression for at least one of the subset of the plurality of media items.

15. The method of claim 14, wherein the direct user impression is one selected from a group consisting of a positive direct user impression and a negative direct user impression.

16. The method of claim 10, further comprising:
receiving, from the advertising server, a plurality of advertisements corresponding to the media category;
identifying a subset of the plurality of advertisements corresponding to the media subcategory; and
presenting an advertisement from the subset of the plurality of advertisements to the user.

17. The method of claim 10, wherein the evaluation engine and the user application are executing on a client device.

18. The method of claim 10, wherein the evaluation engine is executing on a secure data server, and the user application is executing on a first client device.

19. The method of claim 18, further comprising:
providing, to a second client device, the media subcategory for the media category, and
wherein the second client device is accessed by the user.

20. A non-transitory computer readable medium comprising instructions that, when execute by a processor, perform a method for tracking a user's preferences, the method comprising:
obtaining a plurality of attributes of a plurality of media items associated with the user;
determining, by an evaluation engine executing on a client device, a media category and a media subcategory based on the plurality of attributes, wherein the media category comprises the media subcategory;
receiving, from a user application on the client device, a request for the media subcategory, wherein the request comprises the media category;
identifying, by the evaluation engine in response to the request, the media subcategory associated with the media category;
providing, to the user application, the media subcategory for the media category;
obtaining, by an advertising client executing on the client device, the media category;
generating, by the advertising client, an advertising request comprising the media category and excluding the media subcategory; and
submitting, by the advertising client, the advertising request to an advertising server.
